(19) United States
(12) Patent Application Publication
(10) Pub. No.: US 2008/0148202 A1
(43) Pub. Date: Jun. 19, 2008

(54) Circuit pattern design supporting system and circuit pattern designing method

(75) Inventor: Kouichi Konishi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/000,420

(22) Filed: Dec. 12, 2007

(30) Foreign Application Priority Data
Dec. 13, 2006 (JP) 2006-336141

(51) Int. Cl. G06F 9/45; G06F 9/455

(52) U.S. Cl. 716/5; 716/11

(57) ABSTRACT

In a circuit pattern designing method, a distance calculation data is provided to indicate a relation of a shape of a via bundle and an inter-via-bundle distance in which an over-etched portion is generated in a bottom of a via after an etching; and a provisional layout data is provided to contain an arrangement data of vias which form via bundles. A target one of the via bundles in the provisional layout data is set and the shape of the target via bundle is recognized. The inter-via-bundle distance corresponding to the shape of the target via bundle is calculated as an inhibition distance by referring to the distance calculation data; and the inhibition distance is outputted for the target via bundle.

### BACKGROUND OF THE INVENTION

1. Field of the Invention

The present invention relates to a circuit pattern designing method and a circuit pattern design supporting system, which are used for designing a circuit pattern. This Patent application is based on Japanese Patent Application No. 2006-336141. The disclosure of the Japanese Patent Application is incorporated herein by reference.

2. Description of Related Art

As a wiring structure of a semiconductor device, a multi-layer wiring structure is known in which a plurality of wirings are laminated. In the multi-layer wiring structure, a connection of the wirings between layers is achieved through via plugs.

As one of the methods of forming the multi-layer wiring structure, a dual damascene method is known which forms a trench for forming an upper layer wiring and holes for forming via plugs in advance, and a conductor material is filled into the trenches and the holes.

As the dual damascene method, there are a via first method and a trench first method. In the via first method, holes for forming via plugs are first formed to be connected to a lower layer wiring, and then a trench for forming an upper layer wiring is formed. Subsequently, conductor material is filled in the holes and the trench so that a structure is obtained in which the upper layer wiring and the lower layer wiring are connected by the via plugs. Meanwhile, in the trench first method, holes for via plugs are formed after a trench for forming wiring is formed. In the trench first method, a step generated in the trench have an influence when forming the holes. Therefore, the via first method is considered advantageous for a case of forming a fine structure, since it is less influenced by the step.

However, even in the via first method, a step is generated in a hole part for the via plugs (holes) when the trench for forming the wiring is formed. Therefore, in order to reduce the influence of the step, the trench for forming the wiring may be formed after filling an organic film such as an anti-reflection coating in the hole part. Regarding this, Japanese Laid Open Patent Application (JP-P2004-363256A) discloses that an amount of an organic film (anti-reflection coating) is determined based on density of the via holes and other factors.

For forming the multi-layer wiring structure in a high yield, a layout of via plugs for connecting the upper layer and the lower layer is also important. The layout of the via plugs is determined under a restriction of prescribed design rules, considering resolution in a lithography process, an optical proximity effect, a practical-use property, and the like. An example of such design rules is to set the via diameter of 200 nm, and to set the minimum distance between via patterns to 200 nm as shown in Japanese Laid Open Patent Application (JP-P2003-173013A), for example.

However, the inventor of the present invention has noticed that there are the following problems. The process in case of using the above via first method will be described by referring to FIG. 1. First, an etching stopper 107, a via interlayer film 105, an etching stopper 104, and a wiring interlayer film 103 are formed in order on a lower wiring layer 111 in which a wiring 106 is formed. Then, an organic film 102 and a photoresist 101 are formed on the wiring interlayer film 103. It should be noted that the organic film 102 is used as an anti-reflection coating when exposing the photoresist 101. Then, the photoresist 101 is patterned, and an opening is provided at a position where a via plug is to be formed. FIG. 1A is an illustration for showing this state.

Subsequently, etching is performed by using the photoresist 101 as a mask, to form a hole 110 that reaches the etching stopper 107. Further, the photoresist 101 and the organic film 102 are peeled. FIG. 1B is an illustration for showing this state.

Subsequently, a trench for forming the wiring is formed. Although there are some methods considered for forming the trench, it is advantageous in terms of the number of steps to use a method of filling an organic substance 108 to a depth of about a half of the hole 110 (may be referred to as a half-fill process hereinafter). This organic substance 108 is used as an anti-reflection coating at the time of exposure in a latter step as in case of the organic film 102. When the organic substance 108 is filled into the hole 110, the organic substance 108 is formed on the wiring interlayer film 103 as well. Thereafter, a photoresist 109 is formed, and patterning for forming the trench is performed. FIG. 1C is an illustration for showing this state.

From a state shown in FIG. 1C, etching is performed until reaching the etching stopper 104 by using the photoresist 109 as a mask so that the trench for forming the wiring is formed. FIG. 1D is an illustration for showing this state.

Further, an ashing process is performed to remove the organic substance 108 that is filled in the hole 110. Thereafter, etching for removing the etching stopper 107 is performed. FIG. 1E is an illustration for showing this state.

Through the process described above, the trench for forming the wiring and the hole for forming the via plug are formed. Thereafter, a conductor material is filled into the trench and the hole to form the via plug and the upper layer wiring.

In the half-fill process as described above, it is important to precisely control the amount of the organic substance 108 to be filled, when filling the organic substance 108 into the hole 110. For example, if an amount of the organic substance 108 filled into the hole 110 is small, the organic substance 108 as well as the etching stopper 107 are to be completely removed at the time of etching to be performed for forming the trench, and the wiring 106 as a base may be etched as well. That is, as shown in FIG. 2, a part of the wiring 106 is etched, thereby forming an over-etched portion. In the over-etched portion, the wiring 106 is oxidized at the time of the ashing process performed thereafter. When the wiring 106 is oxidized, an electrical reliability thereof becomes deteriorated. Therefore, it is necessary for the organic substance 108 to be filled to such an extent that the over-etched portion is generated.

However, the use of the half-fill process as well as layout to which the conventional designing rule is applied may generate the over-etched portion in the wiring 106 in some cases. As a reason that such an over-etched portion is generated, it is considered that the layout of the via plugs has something to do with this. Specifically, when the organic substance 108 is filled under a same condition, the amount of the organic substance 108 filled in each of the holes 110 becomes smaller in a region where a plurality of vias (holes 110) are densely arranged at a narrow pitch or when the region with densely arranged vias is wider. In the holes 110 with the small amount of filled organic substance 108, the over-etched portion is easily generated when the etching for forming the trenches is performed.

### SUMMARY

According to the present invention, it is provided with a circuit pattern design supporting system and a circuit pattern designing method, in which via plugs can be arranged so as not to generate the over-etched portion.

In a first aspect of the present invention, a circuit pattern designing method includes providing a distance calculation data indicating a relation of a shape of a via bundle and a distance between adjacent via-bundles (to be referred as an inter-via-bundle distance hereinafter) in which an over-etched portion is generated in a bottom of a via after an etching; providing a provisional layout data containing an arrangement data of vias which form via bundles; setting a target one of the via bundles in the provisional layout data; recognizing the shape of the target via bundle; calculating the inter-via-bundle distance corresponding to the shape of the target via bundle as an inhibition distance by referring to the distance calculation data; and outputting the inhibition distance for the target via bundle.

In a second aspect of the present invention, a circuit pattern design supporting system includes a storage section configured to store a distance calculation data indicating a relation of a shape of a via bundle and an inter-via-bundle distance in which an over-etched portion is generated in a bottom of a via after an etching; an input section configured to supply a provisional layout data containing an arrangement data of vias which form via bundles; an output section; and a processing section configured to sets a target one of the via bundles in the provisional layout data, to recognize the shape of the target via bundle, to calculates the inter-via-bundle distance corresponding to the shape of the target via bundle as an inhibition distance by referring to the distance calculation data, and to output the inhibition distance for the target via bundle to said output unit.

### BRIEF DESCRIPTION OF THE DRAWINGS

The above and other objects, advantages and features of the present invention will be more apparent from the following description of certain embodiments taken in conjunction with the accompanying drawings, in which:

FIGS. 1A to 1E are sectional views showing a conventional process of forming a trench and a via;

FIG. 2 is a sectional view showing a state in which an over-etched portion is generated;

FIG. 3 is a conceptual diagram of a provisional layout data in an embodiment of the present invention;

FIG. 4 is a schematic block diagram of a circuit pattern design supporting system according to an embodiment of the present invention;

FIG. 5 is a conceptual diagram showing as first data, a relation between an ARC filing amount and a film thickness of a bottom portion of a via after etching is performed;

FIG. 6 is a conceptual diagram showing as second data, a relation between an ARC filing amount and a distance from a center of a via bundle;

FIG. 7 is a conceptual diagram showing as third data, a relation between an ARC filing amount and a distance from a center of a via bundle;

FIG. 8 is a conceptual diagram showing as fourth data, a relation between an ARC filing amount and an inter-via pitch;

FIG. 9 is a flowchart of a circuit pattern designing method;

FIG. 10 is a conceptual diagram showing a state when setting a check target via bundle;

FIG. 11 is a conceptual diagram showing a state when recognizing an arrangement vias;

FIG. 12 is a conceptual diagram showing contents of data to be outputted; and

FIGS. 13A to 13C are sectional views showing a process of etching for forming a trench.

### DESCRIPTION OF THE PREFERRED EMBODIMENTS

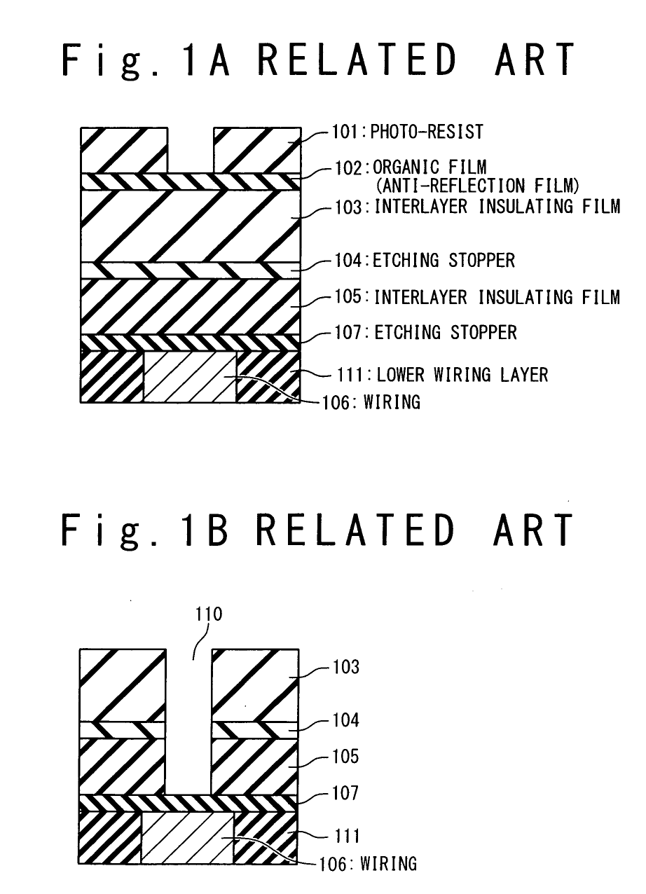

Hereinafter, a circuit pattern design supporting system according to embodiments of the present invention will be described in detail with reference to the attached drawings. The circuit pattern design supporting system checks whether or not there is a problem in the layout of vias on a provisional layout data, and outputs the check result. A manufacturing process of a semiconductor device to which the present invention is applied will be described by using a process shown in FIGS. 1A to 1E as an example. Here, a wiring 106 is formed of copper (Cu), and the etching stopper films 107 and 104 are SiCN films. Also, a via interlayer film 105 and a wiring interlayer film 103 are SiO₂ films, and an organic substance 108 is an ARC (antireflection coating).

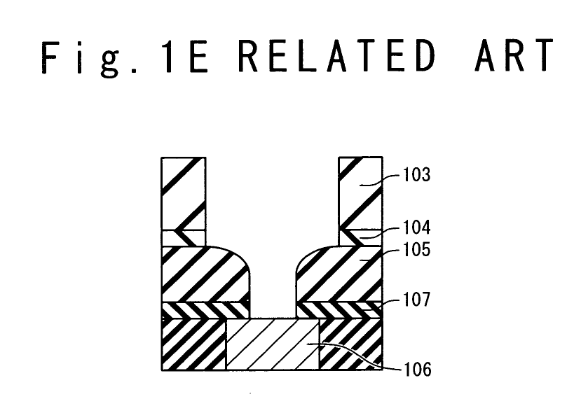

First, a provisional layout data 4 will be described. FIG. 3 is a conceptual diagram showing the provisional layout data 4. As shown in FIG. 3, the provisional layout data 4 is a data including layout data of a plurality of vias 6, and it is designed in advance based on various conditions (e.g., s layout of wirings on a wiring layer, via diameter, and via depth). Further, in order to simplify the description, a set of vias 6 that are adjacent to each other in a certain pitch or less is be referred to as a via bundle 1 hereinafter. Furthermore, when there are the via bundles 1 adjacent to each other, a distance between the via bundles 1 is shown as an inter-via-bundle distance 2. Moreover, regarding the configuration of the via bundle 1, a width direction (X direction in FIG. 3) and a length direction (Y direction in FIG. 3) are defined. For example, when the via bundle 1 is rectangular as shown in FIG. 3, a short-side direction is shown as the width direction and a long-side direction is shown as the length direction.

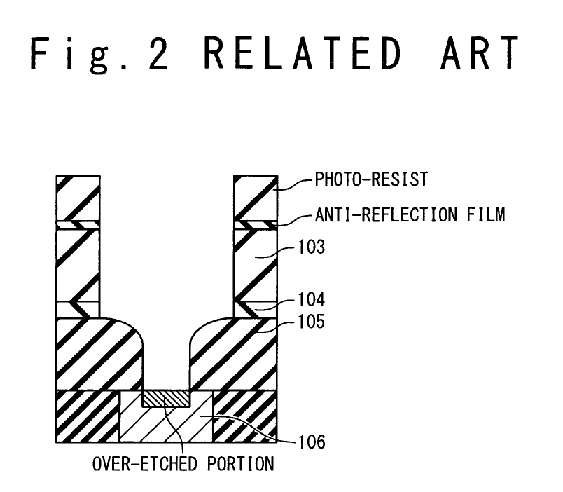

Subsequently, a configuration of the circuit pattern design supporting system 70 will be described. FIG. 4 is a schematic block diagram showing the configuration of the circuit pattern design supporting system 70 according to an embodiment of the present invention. As shown in FIG. 4, the circuit pattern design supporting system 70 includes a control section 40, an input section 50, an output unit 60, a circuit pattern designing program storage section, and a storage section 20.

The control section 40 has a function of controlling the entire of circuit pattern design supporting system 70. The control section 40 is achieved by a central processing unit (CPU) which executes a circuit pattern designing program 30 stored in the storage section, for example. The input section 50 is for inputting a provisional layout data 4 into the circuit pattern design supporting system 70. The input section 50 is composed of a mouse and a keyboard. The output unit 60 is for outputting results processed by the circuit pattern design supporting system 70. The output unit 60 is composed of a display having a display function.

The circuit pattern designing program storage section such as a RAM (Random access memory) stores a circuit pattern designing program 30 as a computer program, which achieves a function of checking a layout of the vias 6 set in the provisional layout data 4 that is inputted through the input section 50. The circuit pattern designing program 30 is composed of a pitch setting section 31 for setting a check target pitch for the provisional layout data 4, a via bundle setting section 32 for selecting a via bundle as a check target for the provisional layout data 4; a shape recognizing section 33 for recognizing the shape of the via bundle as a check target; a inhibition space calculating section 34 for calculating an inhibition distance for the via bundles as check targets; an output section 35 for outputting the results to the output unit 60; and an effective embedded ARC amount calculating section 36 for calculating an effective embedded ARC amount (an effective embedded organic substance amount).

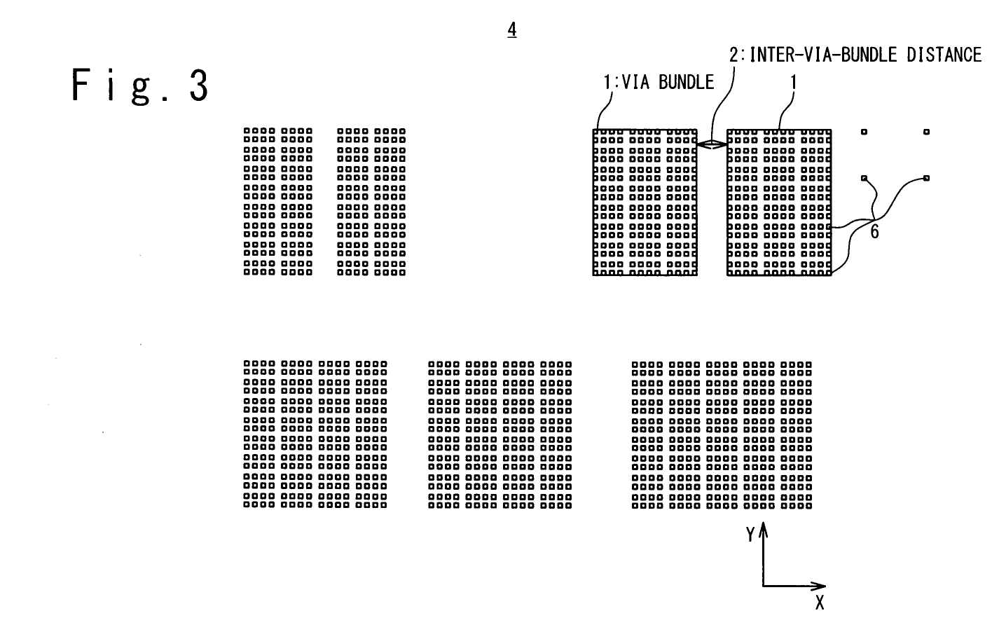

The storage section 20 stores data that is referred when the circuit pattern designing program 30 is executed. Specifically, a first data 21, a second data 22, a third data 23, and a fourth data 24 are stored therein. The contents of each data will be described hereinafter. The first data 21 is a data indicating a relation between a film thickness of a via bottom portion after etching and an embedded ARC amount. The word “after etching” herein means “after the etching that is performed for forming a trench to embed the upper-layer wiring”. FIG. 5 is a conceptual diagram showing the content of the first data 21. In FIG. 5, the film thickness of the via bottom portion after the etching is shown as a film thickness of the etching stopper film 107 after the etching for forming the trench is performed. Further, the embedded ARC amount is an amount of the ARC embedded into the hole 110 before the etching for forming the trench is performed.

Referring to the first data 21, it can be seen that when the embedded ARC amount is smaller, the film thickness of the via bottom portion becomes thinner. Now, the embedded ARC amount when an over-etching starts provides a film thickness of the via bottom portion and is defined as an effective embedded ARC amount. In an area where the embedded ARC amount is less than the effective embedded ARC amount, the organic substance as well as the via bottom portion film (etching stopper film 107) are removed at the time of etching, thereby causing an over-etched portion. From the opposite point of view, it is indicated based on the first data 21 that the over-etched portion can be prevented if the embedded ARC amount is more than the effective embedded ARC amount. In the embodiment, a case is considered where the over-etched portion is generated when the film thickness of the via bottom portion becomes less than 50 Å. In an example shown in FIG. 5, the embedded ARC amount is 1866 Å, when the film thickness of the via bottom portion is 50 Å. Therefore, the effective embedded ARC amount in the this embodiment is 1866 Å. Such the first data 21 may be obtained through processes such as an experiment, and a simulation in advance.

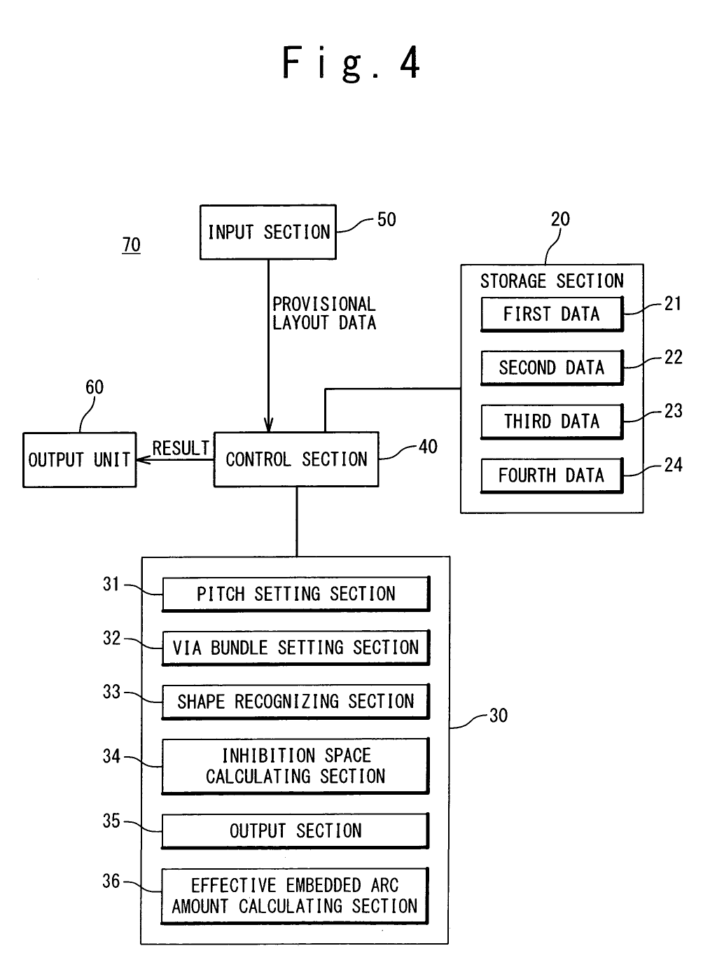

The second data 22 is a data indicating a relation between the inter-via-bundle distance and the embedded ARC amount for each of the shapes of the via bundles. FIG. 6 is a conceptual diagram showing an example of the second data 22. In FIG. 6, a relation between a distance from a center portion of the via bundle 1 and the embedded ARC amount is shown, regarding various inter-via-bundle distances in case where the via bundle has twelve vias (the number of vias=12). It should be noted that it is preferable to express the shape of the via bundle by using the number of vias within the via bundle, a dimension of the via bundle, and a density of the vias in the via bundle. Theses parameters largely affect the embedded ARC amount. Further, it is preferable to express the shape of the via bundle in the shape of the via bundle in the width direction. As has already been described, the embedded ARC amount is influenced by the layout of the vias. Such influence is prominent when the shape of the via bundle has two-dimensional spread. That is, even if the shape of the via bundle is extended longer in the length direction, the fluctuation in the embedded ARC amount hardly occurs as long as the width of the via bundle 1 is small. Therefore, it is effective to express the shape of the via bundle based on a width in the width direction.

In this embodiment, a case where the shape of the via bundle is expressed by using the number of vias lined in the width direction. That is, the second data 22 shown in FIG. 6 shows a relation between the embedded ARC amount and the inter-via-bundle distance when there are twelve vias lined in the width direction within the via bundle. Practically, however, data for other configurations (the number of vias=8, 16, etc.) are also stored. The provisional layout data 4 is normally generated based on a design rule with a restriction on a pitch between the vias. Thus, it is likely to generate an area where a plurality of vias are lined in a pitch that is the very limit of the design rule. That is, it is likely to generate the via bundle in which the vias are lined in the equal pitch. In such a case, the via density within the via bundles can be considered as being substantially constant, so that the number of vias can be used as a parameter for expressing the dimension of the via bundle as well. That is, it becomes possible to express the shape of the via bundle described above by using only the number of vias.

The second data 22 shown in FIG. 6 suggests that the embedded ARC amount becomes smaller as the inter-via-bundle distance becomes smaller. It is also indicated that the embedded ARC amount becomes less than the effective embedded ARC amount when the inter-via-bundle distance is 0.8 μm or less. That is, in case of this shape of the via bundle (the number of vias=12), it could be understood that it is necessary to have the inter-via-bundle distance of 1.2 μm or more in order to arrange the vias so as not to generate an over-etched portion.

As such, by referring to the first data 21 and the second data 22, the inter-via-bundle distance (a distance for an inhibition space) in which the over-etched portion is generated can be obtained when “the shape of the via bundle (the number of vias lined in the width direction)” is given. Thus, the first data 21 and the second data 22 can be considered in the form of combination of them, as the data that indicates the relation between “the shape of the via bundle” and “the inter-via-bundle distance in which the over-etched portion of the via bottom portion is generated after etching”. In this embodiment, a case has been described that the second data 22 is prepared for each of the configurations of the via bundles. However, it may also be constituted to prepare the second data 22 only for the configuration of a single via bundle, and to obtain the inhibition distance from the first data 21 and the second data 23 by performing an interpolating process.

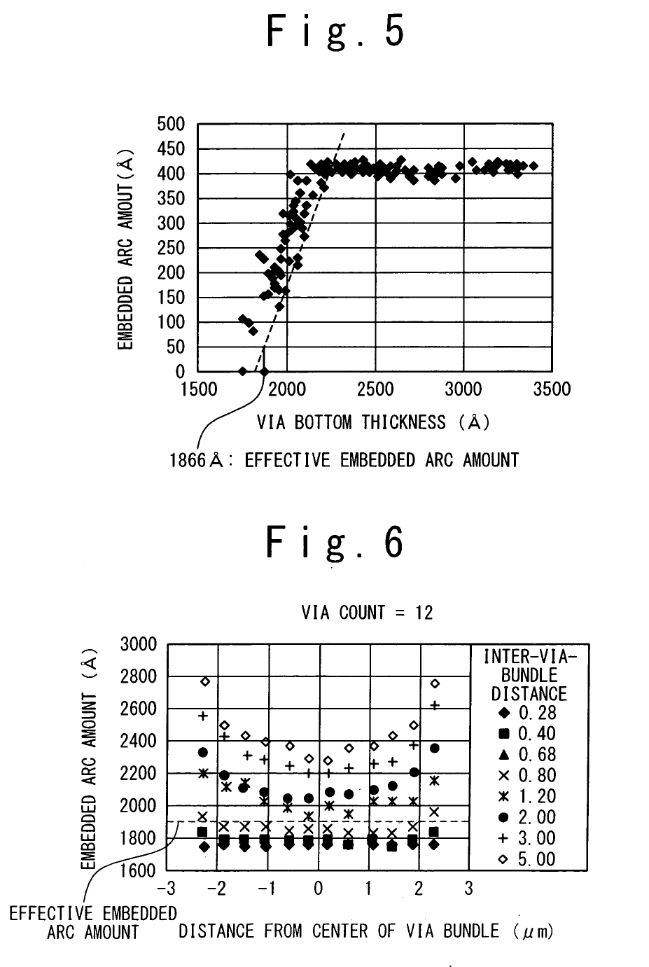

The third data 23 is a data indicating a relation between the shape of the via bundle and the embedded ARC amount, when the inter-via-bundle distance is a saturation pitch (details will be described later). FIG. 7 is a conceptual diagram showing an example of the third data 23. In the example of FIG. 7, a relation between a distance from the center of the via bundle and the embedded ARC amount is shown with respect to the configuration of a plurality of via bundles. It should be noted that the example shown in FIG. 7 is a data when the saturation pitch is 5.0 μm, and indicates a relation when the inter-via-bundle distance is 5.0 μm. As has already been described, the shape of the via bundle is expressed by using the number of vias that are lined in the width direction within the via bundle. The third data 23 suggests that the embedded ARC amount becomes smaller as the shape of the via bundle becomes wider (increases the number of vias). Further, it is also suggested that the embedded ARC amount becomes smaller in the vias located in the center part of the via bundle. Furthermore, when there are twenty or twenty-four vias, the embedded ARC amount in the center part of the via bundle becomes smaller than the effective embedded ARC amount. From this, it could be understood that an over-etched portion is generated if there are twenty or twenty-four vias (when there are twenty vias or more), in a case where the inter-via-bundle distance is 5.0 μm. Such third data 23 may be obtained by carrying out an experiment, a simulation, or the like, in advance.

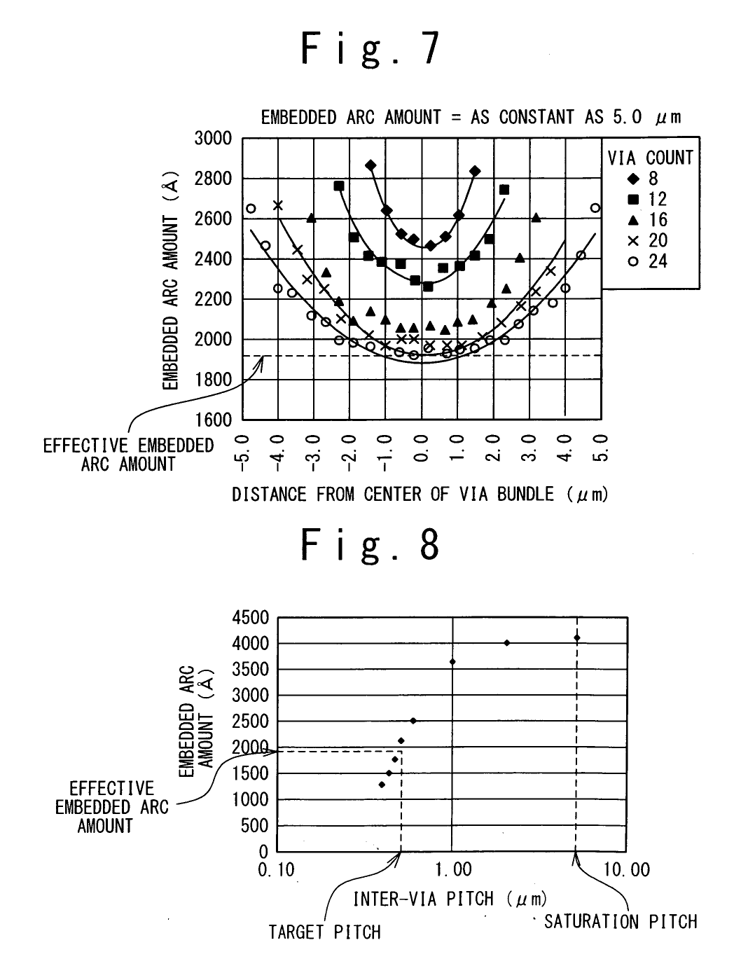

Subsequently, the fourth data 24 will be described. FIG. 8 is a conceptual diagram showing an example of the fourth data 24. As shown in FIG. 8, the fourth data 24 is a data that indicates a relation of an inter-via pitch and the embedded ARC amount. The fourth data 24 is a data when there is a single via bundle and “the via bundle has a sufficiently large dimension”. The embedded ARC amount taken in the vertical axis shows the embedded ARC amount in the vias in the center part of the via bundle. It should be noted that “the via bundle has a sufficiently large dimension” indicates a case where the embedded ARC amount remains unchanged even if the dimension of the via bundle is fluctuated. As could be understood from FIG. 7 (the second data 22), the embedded ARC amount becomes decreased as the dimension of the via bundle becomes wider. However, such decrease in the embedded ARC amount can be observed only to a certain dimension of the via bundle, and a change in the embedded ARC amount becomes less after exceeding that certain dimension. Specifically, there is almost no difference in the embedded ARC amount between the case of twenty vias and the case of twenty-four vias. Such range of the via bundle dimension is a range meant by “the via bundle has a sufficiently large dimension”. The fourth data 24 is used when setting the inhibition distance and the check target pitch.

The inhibition shape will be described. The inhibition shape can be obtained by referring to the fourth data 24 and the third data 23. As could be seen from the fourth data 24, the embedded ARC amount is increased as the inter-via pitch becomes larger. However, in an area where the inter-via pitch is a certain value or more, the effective embedded ARC amount stays substantially unchanged. The inter-via pitch in which the effective embedded ARC amount starts to become substantially unchanged in this way is referred to as the “saturation pitch” for convenience. The fourth data 24 indicates that the embedded ARC amount of a given via is hardly influenced by the adjacent vias, when a plurality of vias are lined at the saturation pitch or larger.

Now, the third data 23 shown in FIG. 7 will be referred to. The third data 23 of FIG. 7 is a data when the inter-via-bundle distance is the saturation pitch (5 μm). That is, it is the data when the embedded ARC amount of each via within a via bundle is not influenced by adjacent via bundles. However, even though there is no influence from the adjacent via bundles, the embedded ARC amount in the center part is smaller than the effective embedded ARC amount when the shape of the via bundle in the third data 23 is expressed to be twenty vias and twenty-four vias. That is, even though there is no influence of the adjacent via bundles, an over-etched portion is generated in these via bundles. This indicates that the over-etched portion is generated regardless of the influence of the adjacent via bundles, because the density of the via bundle itself is too high. Such shape of the via bundle is referred to as the inhibition shape. In the via bundle of the inhibition shape, an over-etched portion is generated therein, regardless of any value of the inhibition distance.

Subsequently, a check target pitch will be described. The check target pitch is obtained as an inter-via pitch corresponding to the effective embedded ARC amount. As shown in FIG. 8, it could be seen that the embedded ARC amount becomes smaller as the inter-via pitch becomes narrower (smaller). When “the via bundle has a sufficiently large dimension”, the embedded ARC amount has almost no dependency on the inter-via-bundle distance, and comes to have a dependency only on the pitch of the vias within the via bundle. Therefore, even when there is no adjacent via bundle, i.e. when there is only a single via bundle, a fluctuation in the embedded ARC amount is generated depending on the pitch between the vias within the via bundle. Further, in such a sufficiently wide via bundle, it is considered that the embedded ARC amount is most likely to become less (likely to generate over-etched portion) from the viewpoint of the dimension of the via bundle. Therefore, in the fourth data 24, the embedded ARC amount never become equal to or less than the effective embedded ARC amount regardless of the dimension of the via bundle, in case of the via bundle having the via pitch in which the embedded ARC amount becomes larger than the effective embedded ARC amount. That is, there is no over-etched portion to be generated. Accordingly, among the via bundles in the provisional layout 4, there is a possibility of having an over-etched portion only in the via bundle of the inter-via pitch that is equal to or smaller than the inter-via pitch (check target pitch) corresponding to the effective embedded ARC amount in the fourth data 24.

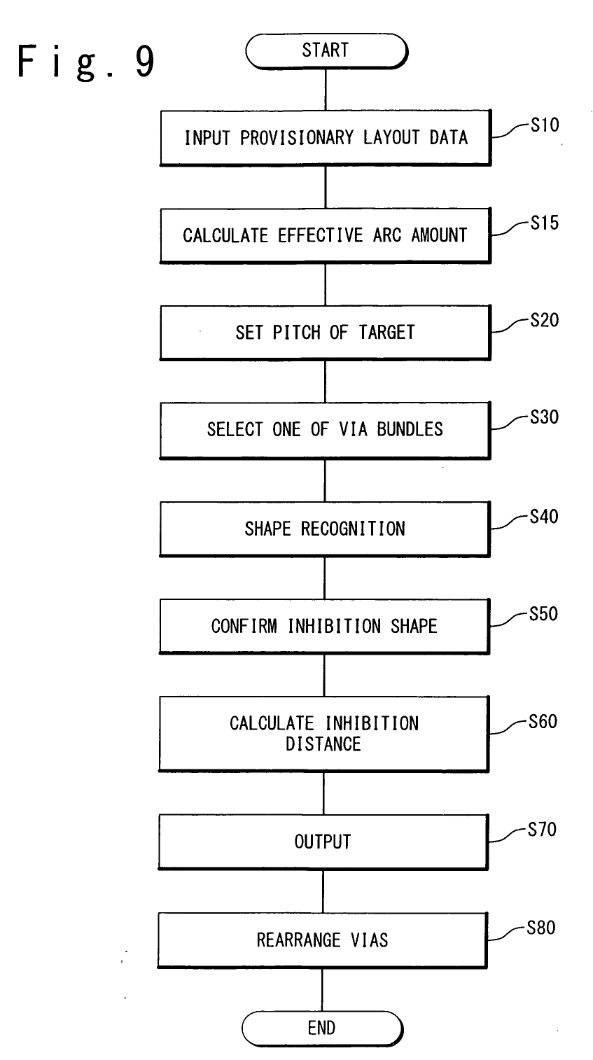

Subsequently, the operation of the circuit pattern design supporting system 70 having the above-described configuration will be described. FIG. 9 is a flowchart showing an operation of the circuit pattern design supporting system 70. Through a process of steps S10 to S50 shown in FIG. 9, it is determined whether or not a layout of vias in a provisional layout data 4 is adequate, and the result thereof is informed to a user through a step S60. Details of each step will be described hereinafter.

### Step S10: Input Provisional Layout Data

First, the provisional layout data 4 is supplied to the control section 40 from the input section 50. As has already been described with reference to FIG. 3, the provisional layout data 4 is a data that is produced based on a prescribed condition, which shows a state in which a plurality of vias 6 are arranged.

### Step S15: Calculate Effective Embedded ARC Amount

Subsequently, the effective embedded ARC amount calculating section 36 refers to the first data 21 to calculate the effective embedded ARC amount. This step may be performed at any stages as long as it is performed before setting a check target pitch (step S20) and calculating the inhibition shape (step S50) which will be described later. For example, it may be performed before the provisional layout data 4 is inputted.

### Step S20: Set Check Target Pitch

Subsequently, the pitch setting section 31 refers to the fourth data 24 to obtain the inter-via pitch of a check target corresponding to the effective embedded ARC amount as a check target pitch.

### Step S30: Set Target Via Bundle

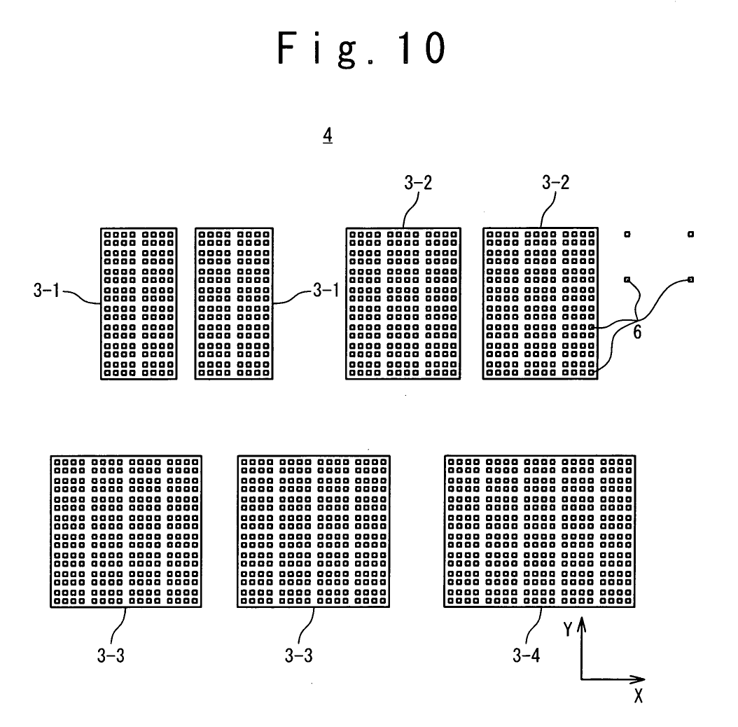

Subsequently, the via bundle setting section 32 sets groups of vias which are arranged in the check target pitch or narrower, as check target via bundles 3 in a layout of the vias within the provisional layout data 4. FIG. 10 conceptually shows setting states of the check target via bundles 3. As shown in FIG. 10, the via bundles 3-1, 3-2, 3-3, and 3-4 of a plurality of via bundles are set as check target via bundles.

### Step S40: Recognize Arrangement

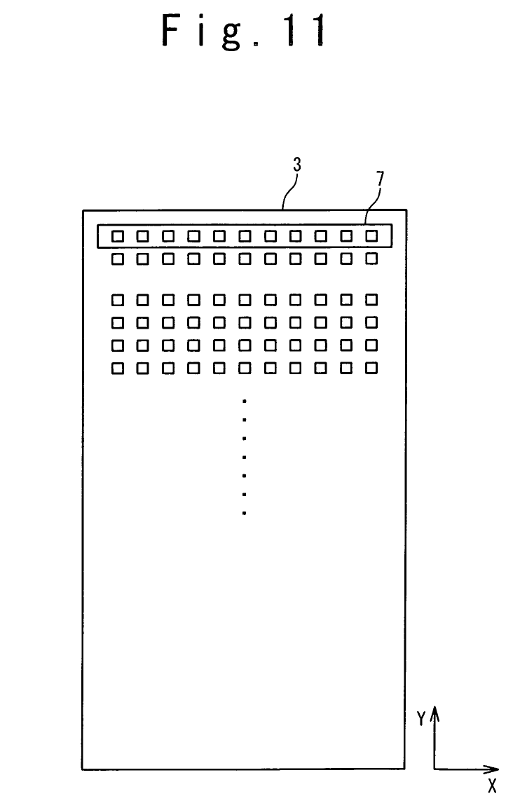

Subsequently, the shape recognizing section 33 recognizes a shape of each check target via bundle 3. FIG. 11 is a conceptual diagram showing one recognized shape. As shown in FIG. 11, a row 7 of vias that are lined in the width direction (X direction) is recognized from the vias within the check target via bundle 3, and the number of vias in the row 7 is counted. That is, the number of vias lined in the width direction is recognized.

### Step S50: Check Inhibition shape

Subsequently, the inhibition space calculating section 34 refers to the fourth data 24 to calculate the saturation pitch. Further, the inhibition space calculating section 34 obtains the inhibition shape by referring to the third data 23 when the inter-via-bundle distance matches the calculated saturation pitch. It is checked whether the shape of the via bundle recognized at the step S40 is the inhibition shape. “Error” is related to the check target via bundle 3 that is the inhibition shape, and the process is advanced to a next step S70. The process of a next step S60 is performed for the check target via bundle 3 that is not the inhibition shape.

### Step S60: Calculate Inhibition Distance

Subsequently, the inhibition space calculating section 34 refers to the second data 22 and the third data 23 to calculate the inter-via-bundle distance corresponding to the shape recognized at the step S40 (the number of vias) and corresponding to the effective embedded ARC amount. Then, the calculated inter-via-bundle distance is taken as an inhibition distance 5. The inhibition space calculating section 34 calculates an inhibition distance 5 for each of the check target via bundles 3, and determines an inhibition space based on the inhibition distance 5, and then the process is advanced to the next step S70.

### Step S70: Output

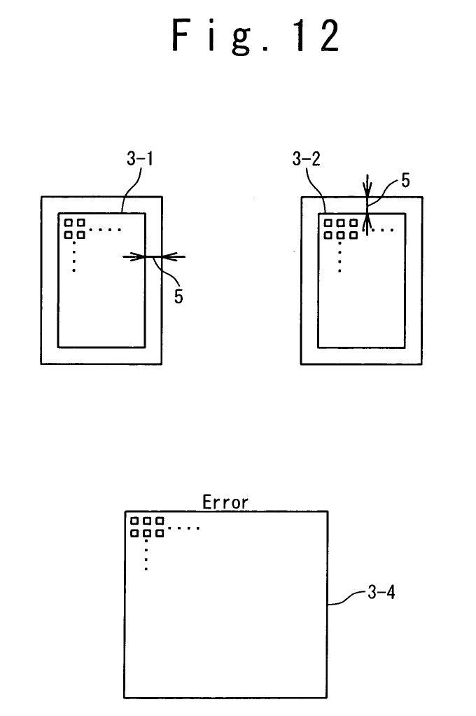

Subsequently, the output section 35 outputs the inhibition distance 5 obtained at the step S50 to the output unit 60, by relating it to the check target via bundle 3. FIG. 12 shows display examples on a display apparatus, assuming that the output unit 60 is the display apparatus. The inhibition distance 5 is related to each of the check target via bundles (3-1, 3-2). Further, the check target via bundle 3-4 is the via bundle that has been confirmed as the inhibition shape in the step S50. The output section 35 outputs such a via bundle by relating “error” thereto.

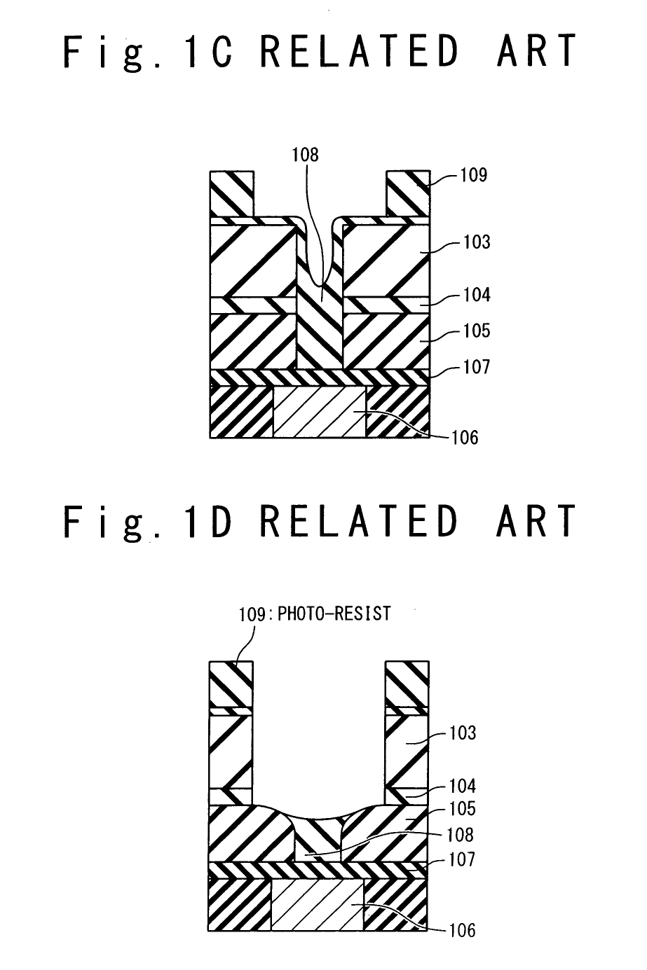

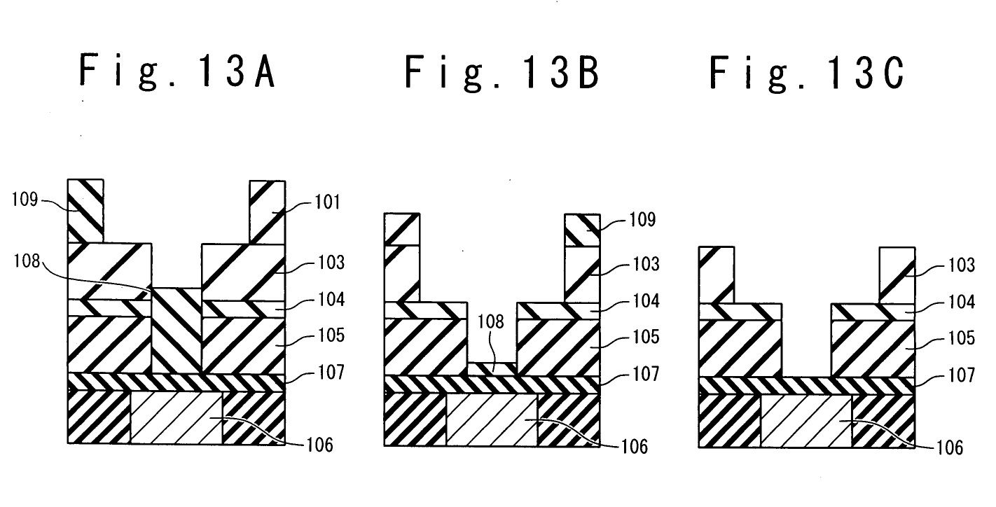

The user can know whether or not an over-etched portion is generated, based on the outputted result. When there is not another via or via bundle within the inhibition distance 5, the ARC 108 is sufficiently filled into the vias of the via bundle at the time of filling the ARC, as shown in FIG. 13A. Therefore, the ARC 108 still remains in the vias even after the etching for forming the trench is performed (FIG. 13B). The remained ARC 108 is removed along with the photoresist 109 in a subsequent ashing step (FIG. 13C). Therefore, an over-etched portion shown in FIG. 2 is not generated into the wiring 106 at the time of performing the etching for forming the trench.

Meanwhile, when another via bundle or via existed within the inhibition distance 5, it indicates that there is a possibility of generating an over-etched portion. In this case, it is possible to obtain for the provisional layout, the layout data, in which no over-etched portion is generated data 4, by rearranging the vias such that the via or the via bundle is not arranged in a space of the inhibition distance 5. Such rearrangement may be performed by the user or by the circuit pattern design supporting system 70 described in the present embodiment (step S80).

As described above, this embodiment can determine whether or not there is a possibility of generating an over-etched portion in the via arrangement of the provisional layout data 4, since there are provided with the data (the first data-the third data) which indicates a relation between “the shape of the via bundle” and “the inter-via-bundle distance in which the over-etched portion in the via bottom portion is generated after etching”. Further, since the inhibition distance 5 is calculated and outputted, the provisional layout data 4 that is possible to generate the over-etched portion can be rearranged so as not to generate the over-etched portion easily.

Although the present invention has been described above in connection with several embodiments thereof, it would be appreciated by those skilled in the art that those embodiments are provided solely for illustrating the present invention, and should not be relied upon to construe the appended claims in a limiting sense.

What is claimed is:

1. A circuit pattern designing method comprising:
providing a distance calculation data indicating a relation of a shape of a via bundle and an inter-via-bundle distance in which an over-etched portion is generated in a bottom of a via after an etching;
providing a provisional layout data containing an arrangement data of vias which form via bundles;
setting a target one of the via bundles in the provisional layout data;
recognizing the shape of the target via bundle;
calculating the inter-via-bundle distance corresponding to the shape of the target via bundle as an inhibition distance by referring to the distance calculation data; and
outputting the inhibition distance for the target via bundle.

2. The circuit pattern designing method according to claim 1, further comprising:
calculating an embedded organic substance amount in which the over-etched portion is not generated after the etching, as an effective embedded organic substance amount,
wherein the distance calculation data comprises a first data which indicates a relation of a film thickness of the via bottom after the etching and the embedded organic substance amount, and a second data which indicates a relation of the inter-via-bundle distance and the embedded organic substance amount for every via bundle shape,
said calculating an embedded organic substance amount comprises:
calculating the effective embedded organic substance amount based on the first data, and
said calculating the inter-via-bundle distance comprises:
calculating the inter-via-bundle distance corresponding to the shape of the target via bundle and the effective embedded organic substance amount as the inhibition distance by referring to the second data.

3. The circuit pattern designing method according to claim 2, further comprising:
setting a target via pitch, and
said setting a target via bundle comprises:
selecting a set of the vias which are arranged in a pitch which is smaller than the target via pitch, to set the target via bundle.

4. The circuit pattern designing method according to claim 3, wherein the distance calculation data further comprises a fourth data which indicates a relation of a via pitch and the embedded organic substance amount when the via bundle is sufficiently large,
said setting a target pitch comprises:
setting a via pitch corresponding to the effective embedded organic substance amount as the target via pitch by referring to the fourth data.

5. The circuit pattern designing method according to claim 4, further comprising:
calculating as a saturation pitch, the via pitch when the embedded organic substance amount does not depend on the via pitch, by referring to the fourth data,
wherein the distance calculation data further comprises a third data which indicates a relation of the via bundle shape and the embedded organic substance amount when the inter-via-bundle distance is equal to the saturation pitch; and
determining the via bundle shape when the embedded organic substance amount is less than the effective embedded organic substance amount as an inhibition shape, by referring to the third data.

6. The circuit pattern designing method according to claim 1, wherein the via bundle shape is expressed by a width of the via bundle.

7. The circuit pattern designing method according to claim 6, wherein the via bundle shape is determined based on a number of vias in an axis direction.

8. The circuit pattern designing method according to claim 1, further comprising:
generating a new layout data by rearranging the vias in the provisional layout data; and
forming a multi-layer wiring structure based on the new layout data.

9. A circuit pattern design supporting system comprising:
a storage section configured to store a distance calculation data indicating a relation of a shape of a via bundle and an inter-via-bundle distance in which an over-etched portion is generated in a bottom of a via after an etching;
an input section configured to supply a provisional layout data containing an arrangement data of vias which form via bundles;
an output section; and
a processing section configured to sets a target one of the via bundles in the provisional layout data, to recognize the shape of the target via bundle, to calculates the inter-via-bundle distance corresponding to the shape of the target via bundle as an inhibition distance by referring to the distance calculation data, and to output the inhibition distance for the target via bundle to said output section.

10. The circuit pattern design supporting system according to claim 9, where said distance calculation data comprises a first data which indicates a relation of a film thickness of the via bottom after the etching and the embedded organic substance amount, and a second data which indicates a relation of the inter-via-bundle distance and the embedded organic substance amount for every via bundle shape, and
said processing section calculates an embedded organic substance amount in which the over-etched portion is not generated after the etching, as an effective embedded organic substance amount, calculates the effective embedded organic substance amount based on the first data, and calculates the inter-via-bundle distance corresponding to the shape of the target via bundle and the effective embedded organic substance amount as the inhibition distance by referring to the second data.

11. The circuit pattern design supporting system according to claim 10, wherein said processing section selects a set of the vias which are arranged in a pitch which is smaller than a target via pitch, to set the target via bundle.

12. The circuit pattern design supporting system according to claim 11, wherein said distance calculation data further comprises a fourth data which indicates a relation of a via pitch and the embedded organic substance amount when the via bundle is sufficiently large, and
said processing section sets a via pitch corresponding to the effective embedded organic substance amount as the target via pitch by referring to the fourth data.

13. The circuit pattern design supporting system according to claim 12, wherein said distance calculation data further comprises a third data which indicates a relation of the via bundle shape and the embedded organic substance amount when the inter-via-bundle distance is equal to the saturation pitch, and
said processing section calculates as a saturation pitch, the via pitch when the embedded organic substance amount does not depend on the via pitch, by referring to the fourth data, and determines the via bundle shape when the embedded organic substance amount is less than the effective embedded organic substance amount as an inhibition shape, by referring to the third data.

14. The circuit pattern design supporting system according to claim 9, wherein the via bundle shape is expressed by a width of the via bundle.

15. The circuit pattern design supporting system according to claim 14 wherein the via bundle shape is determined based on a number of vias in an axis direction.

16. The circuit pattern design supporting system according to claim 9, wherein said processing section generates a new layout data by rearranging the vias in the provisional layout data; and forms a multi-layer wiring structure based on the new layout data.

17. A computer-readable software product which stores a program for realizing a circuit pattern designing method, wherein said circuit pattern designing method comprises:
providing a distance calculation data indicating a relation of a shape of a via bundle and an inter-via-bundle distance in which an over-etched portion is generated in a bottom of a via after an etching;
providing a provisional layout data containing an arrangement data of vias which form via bundles;
setting a target one of the via bundles in the provisional layout data;
recognizing the shape of the target via bundle;
calculating the inter-via-bundle distance corresponding to the shape of the target via bundle as an inhibition distance by referring to the distance calculation data; and
outputting the inhibition distance for the target via bundle.

18. The computer-readable software product according to claim 17, wherein said circuit pattern designing method further comprises:
calculating an embedded organic substance amount in which the over-etched portion is not generated after the etching, as an effective embedded organic substance amount,
wherein the distance calculation data comprises a first data which indicates a relation of a film thickness of the via bottom after the etching and the embedded organic substance amount, and a second data which indicates a relation of the inter-via-bundle distance and the embedded organic substance amount for every via bundle shape,
said calculating an embedded organic substance amount comprises:
calculating the effective embedded organic substance amount based on the first data, and
said calculating the inter-via-bundle distance comprises:
calculating the inter-via-bundle distance corresponding to the shape of the target via bundle and the effective embedded organic substance amount as the inhibition distance by referring to the second data.

19. The computer-readable software product according to claim 17, wherein said circuit pattern designing method further comprises:
generating a new layout data by rearranging the vias in the provisional layout data; and
forming a multi-layer wiring structure based on the new layout data.
